(19) United States
(12) Patent Application Publication
(10) Pub. No.: US 2014/0117678 A1
(43) Pub. Date: May 1, 2014

(54) INTERNAL LATCH CAMMING WEDGES FOR CLOSURE ASSEMBLY LATERAL CONSTRAINT

(71) Applicant: GM GLOBAL TECHNOLOGY OPERATIONS LLC, Detroit, MI (US)

(72) Inventors: Scott W. Thorpe, Milford, MI (US); Altaf S. Iman, Troy, MI (US); Michael E. McGuire, Milford, MI (US); Shawn G. Quinn, Grand Blanc, MI (US)

(73) Assignee: GM GLOBAL TECHNOLOGY OPERATIONS LLC, Detroit, MI (US)

(21) Appl. No.: 13/659,980

(22) Filed: Oct. 25, 2012

(51) Int. Cl. E05C 19/00; E05B 15/02

(52) U.S. Cl. 292/2

(57) ABSTRACT

A closure assembly for a vehicle includes a striker assembly and a latch mechanism. The latch mechanism includes a housing rotatably supporting a first wedge block for rotation about a first axis, and a second wedge block for rotation about a second axis. The first wedge block includes a first cam surface that engages the striker assembly as the latch mechanism moves along a path to limit lateral movement of the latch mechanism in a first direction transverse to the path. The second wedge block includes a second cam surface that engages the striker assembly as the latch mechanism moves along the path to limit lateral movement of the latch mechanism in a second direction transverse to the path, opposite the first direction. The first wedge block and the second wedge block are disposed within an interior space of the housing.

### TECHNICAL FIELD

The invention generally relates to a closure assembly for securing a moveable panel, such as a lift gate, a decklid, or a hatch, to a body of a vehicle.

### BACKGROUND

Vehicles include moveable panels for sealing openings in a body of the vehicle. The moveable panels may include but are not limited to a lift gate for sealing a rear opening of a Sport Utility Vehicle (SUV), a decklid for sealing a trunk space of a sedan, or a hatch for sealing a rear opening of a hatchback. It should be appreciated that the opening and the moveable panel may be located anywhere on the vehicle, and may be positioned in any suitable orientation.

A closure assembly secures the moveable panel relative to the body of the vehicle. The closure assembly includes a striker assembly and a latch mechanism. Typically, the striker assembly is attached to the body, and a latch mechanism is attached to and moveable with the panel. However, the relative positions of the striker assembly and the latch mechanism may be reversed. The striker assembly includes a wire striker, which generally forms a loop. The panel and the latch mechanism move along a path into and out of engagement with the striker assembly. The latch mechanism engages the wire striker of the striker assembly in interlocking engagement to secure the panel relative to the body. The interlocking engagement between the striker assembly and the latch mechanism must minimize and/or eliminate movement of the panel in a lateral direction relative to the path to prevent undesirable noise, paint chips, etc.

### SUMMARY

A closure assembly for securing a moveable panel relative to a body of a vehicle is provided. The closure assembly includes a striker assembly and a latch mechanism. The striker assembly includes a base and a wire striker fixedly attached to the base. The latch mechanism is moveable along a path relative to the striker assembly. The latch mechanism includes a housing supporting a lock bolt moveable between a closed position and an open position. When in the closed position, the lock bolt engages the wire striker in interlocking engagement to secure the latch mechanism relative to the striker assembly. When in the open position, the lock bolt is disengaged from the wire striker to allow movement of the latch mechanism along the path relative to the striker assembly. The latch mechanism includes a first wedge block supported by and rotatably attached to the housing for rotation about a first axis. The first wedge block includes a first cam surface defining a variable distance between the first cam surface and the first axis. The first cam surface engages the striker assembly as the latch mechanism moves along the path to limit lateral movement of the latch mechanism in a first direction transverse relative to the path.

A vehicle is also provided. The vehicle includes a body defining an opening, and a panel moveably attached to the body for selectively sealing the opening. A closure assembly interconnects the body and the panel for selectively securing the panel relative to the body in a closed position. The closure assembly includes a striker assembly and a latch mechanism. The striker assembly includes a base and a wire striker fixedly attached to the base. The latch mechanism is moveable along a path relative to the striker assembly. The latch mechanism includes a housing supporting a lock bolt. The lock bolt is moveable between a closed position and an open position. When in the closed position, the lock bolt engages the wire striker in interlocking engagement to secure the latch mechanism relative to the striker assembly. When in the open position, the lock bolt is disengaged from the wire striker to allow movement of the latch mechanism along the path relative to the striker assembly. The latch mechanism includes a first wedge block and a second wedge block. The first wedge block is supported by and rotatably attached to the housing for rotation about a first axis. The second wedge block is supported by and rotatably attached to the housing for rotation about a second axis. The second wedge block is disposed opposite the first wedge block across the path. The first wedge block includes a first cam surface. The first cam surface defines a variable distance between the first cam surface and the first axis. The first cam surface engages the striker assembly as the latch mechanism moves along the path to limit lateral movement of the latch mechanism in a first direction transverse relative to the path. The second wedge block includes a second cam surface. The second cam surface defines a variable distance between the second cam surface and the second axis. The second cam surface engages the striker assembly as the latch mechanism moves along the path to limit lateral movement of the latch mechanism in a second direction transverse relative to the path. The second direction is opposite the first direction.

Accordingly, the first wedge block and the second wedge block bias against the striker assembly in opposite directions to limit lateral movement of the latch mechanism, thereby limiting lateral movement of the panel. Because the first wedge block and the second wedge block are rotatable independent of each other, the first cam surface and the second cam surface may each independently engage the striker assembly to prevent lateral movement thereof, even when the latch mechanism is not centered relative to the striker assembly.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross sectional view of a vehicle.

FIG. 2 is a schematic plan view of a closure assembly for the vehicle in an open position.

FIG. 3 is a schematic plan view of the closure assembly in a closed position.

FIG. 4 is another schematic plan view of the closure assembly in the closed position, wherein a latch mechanism of the closure assembly is misaligned with a striker assembly of the closure assembly.

FIG. 5 is a schematic plan view of an alternative embodiment of the closure assembly in a closed position, wherein a latch mechanism of the alternative embodiment of the closure assembly is misaligned with a striker assembly of the alternative embodiment of the closure assembly.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

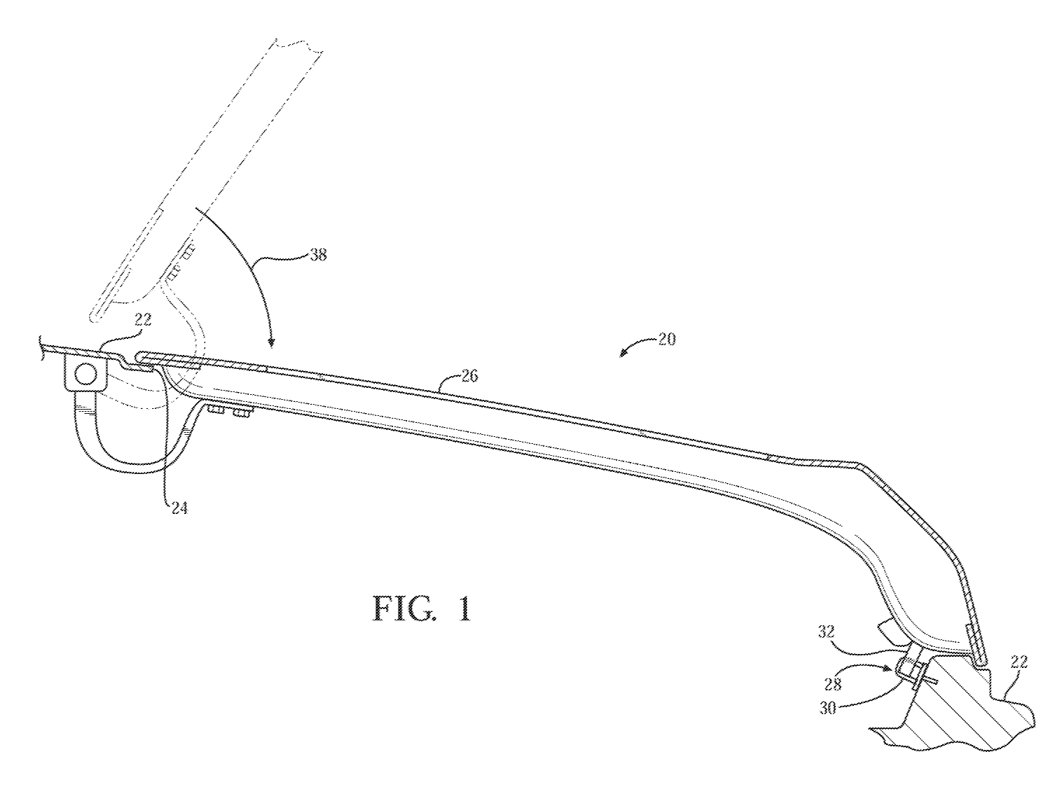

Referring to the Figures, wherein like numerals indicate like parts throughout the several views, a vehicle is generally shown at 20. Referring to FIG. 1, the vehicle 20 includes a body 22 that defines an opening 24. The opening 24 may include, for example, a rear access to a cargo van or a sport utility vehicle 20, or a trunk to a sedan. It should be appreciated that the opening 24 may be located and oriented in any position on the body 22 of the vehicle 20. A panel 26 is moveably attached to the body 22, for example, by one or more hinges. The panel 26 moves between an open position to allow access to the opening 24, and a closed position to selectively seal the opening 24. The panel 26 may include, for example, a deck lid, a lift gate, a hatch back, a door, or some other closure panel 26.

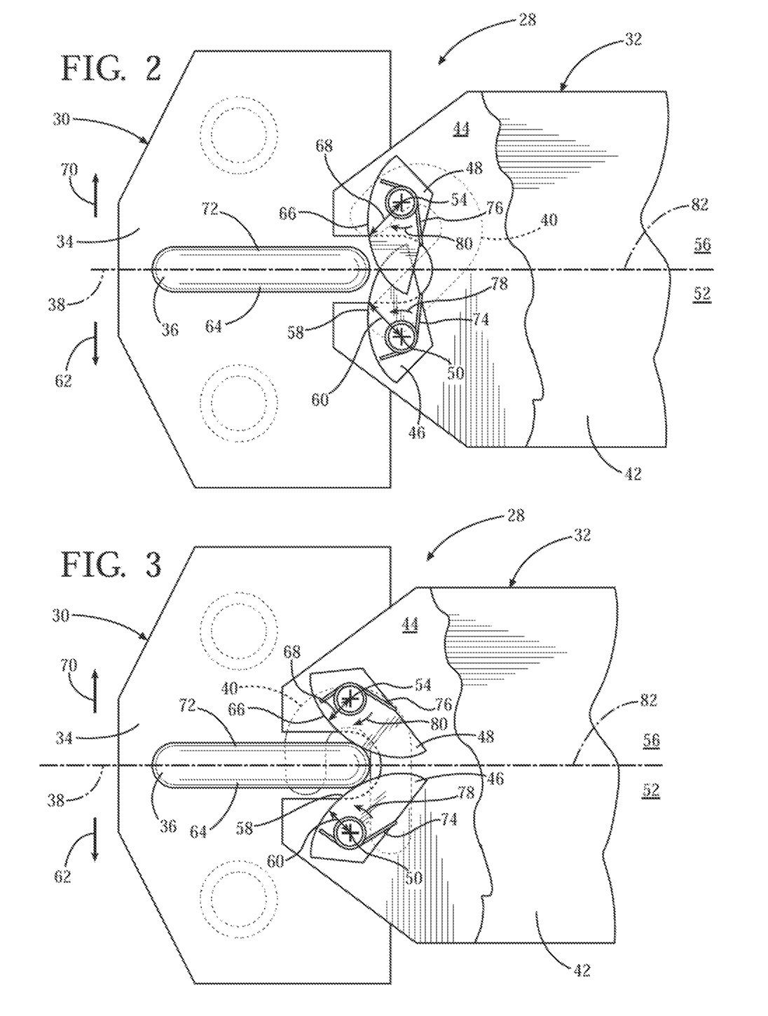

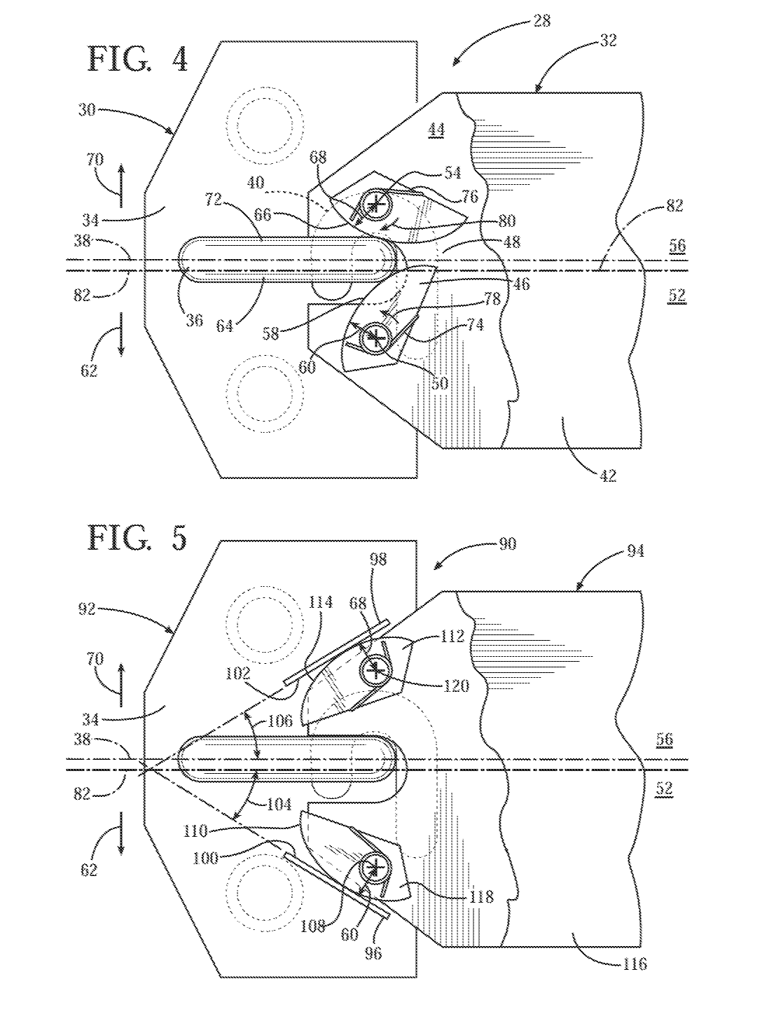

A closure assembly 28 secures the panel 26 relative to the body 22 when the panel 26 is disposed in the closed position. The closure assembly 28 includes a striker assembly 30 and a latch mechanism 32. Referring to FIGS. 2 through 4, the striker assembly 30 includes a base 34 supporting a wire striker 36, with the wire striker 36 fixedly attached to the base 34. Preferably, the striker assembly 30 is attached to the body 22, and the latch mechanism 32 is attached to the panel 26. However, it should be appreciated that the relative positions of the striker assembly 30 and the latch mechanism 32 may be reversed, with the latch mechanism 32 attached to the body 22, and the striker assembly 30 attached to and moveable with the panel 26. The wire striker 36 may define a loop as is known. As shown, the latch mechanism 32 moves with the panel 26 along a path 38 relative to the striker assembly 30, and includes an open position, shown in FIG. 2, and a closed position, shown in FIGS. 3 and 4. When in the closed position, the latch mechanism 32 engages the wire striker 36 in interlocking engagement to secure the latch mechanism 32 relative to the striker assembly 30. For example, a lock bolt 40 may rotate around or otherwise grasp the wire striker 36. When the latch mechanism 32 is in the open position, the latch mechanism 32 does not engage the wire striker 36 in interlocking engagement, i.e., the latch mechanism 32 is disengaged from the interlocking engagement with the wire striker 36, to allow movement of the latch mechanism 32 and the panel 26 relative to the striker assembly 30. The latch mechanism 32 and wire striker 36 may include any suitable combination, and/or configuration known to those skilled in the art and/or capable of securely latching the panel 26 to the body 22. Accordingly, the specifics of the wire striker 36, the latch mechanism 32, and the operation of the interlocking engagement therebetween are not described in detail herein.

The latch mechanism 32 includes a housing 42 that defines an interior space 44. The housing 42 rotatably supports a first wedge block 46 and a second wedge block 48 within the interior space 44 of the housing 42. Accordingly, the first wedge block 46 and the second wedge block 48 are at least partially disposed within the interior space 44 of the housing 42. The first wedge block 46 is supported by and rotatably attached to the housing 42. The first wedge block 46 is rotatable about a first axis 50. The first axis 50 is laterally spaced from the path 38 of the latch mechanism 32, and is disposed on a first side 52 of the path 38. The second wedge block 48 is also supported by and rotatably attached to the housing 42. The second wedge block 48 is rotatable about a second axis 54. The second axis 54 is laterally spaced from the path 38 of the latch mechanism 32, and is disposed on a second side 56 of the path 38. The second wedge block 48 is disposed opposite the first wedge block 46 across the path 38. Preferably, the first axis 50 and the second axis 54 are disposed equidistant from the path 38 on opposite sides of the path 38, i.e., the first axis 50 is disposed on one side of the path 38 a pre-defined distance from the path 38, and the second axis 54 is disposed on another side of the path 38, the same pre-defined distance from the path 38. The first wedge block 46 is rotatable relative to the housing 42 independently of the second wedge block 48. Similarly, the second wedge block 48 is rotatable relative to the housing 42 independently of the first wedge block 46.

The first wedge block 46 includes a first cam surface 58. The first cam surface 58 extends along a continuously curved edge surface of the first wedge block 46 to define a curved surface relative to the first axis 50. Accordingly, the first cam surface 58 defines a first variable distance 60 between the first cam surface 58 and the first axis 50. The first cam surface 58 engages the striker assembly 30 as the latch mechanism 32 moves along the path 38 to limit lateral movement of the latch mechanism 32 in a first direction 62 transverse relative to the path 38. The striker assembly 30 includes a first engaging surface 64 configured for engaging the first cam surface 58. The first engaging surface 64 may be defined, for example and as shown in FIGS. 2 through 4, by an edge surface of the wire striker 36.

The first cam surface 58 engages the striker assembly 30 as the latch mechanism 32 moves along the path 38. More specifically, the first cam surface 58 engages the first engaging surface 64 of the striker assembly 30. It should be appreciated that the area of contact between the first engaging surface 64 and the first cam surface 58 moves relative to the first cam surface 58 and the first engaging surface 64 as the latch mechanism 32 moves along the path 38. The first cam surface 58 of the first wedge block 46 engages the latch mechanism 32 to limit lateral movement of the latch mechanism 32 in the first direction 62 relative to the path 38.

The second wedge block 48 includes a second cam surface 66. The second cam surface 66 extends along a continuously curved edge surface of the second wedge block 48 to define a curved surface relative to the second axis 54. Accordingly, the second cam surface 66 defines a second variable distance 68 between the second cam surface 66 and the second axis 54. The second cam surface 66 engages the striker assembly 30 as the latch mechanism 32 moves along the path 38 to limit lateral movement of the latch mechanism 32 in a second direction 70 transverse relative to the path 38. The second direction 70 is opposite the first direction 62. The striker assembly 30 includes a second engaging surface 72 configured for engaging the second cam surface 66. The second engaging surface 72 may be defined, for example and as shown in FIGS. 2 through 4, by an edge surface of the wire striker 36.

The second cam surface 66 engages the striker assembly 30 as the latch mechanism 32 moves along the path 38. More specifically, the second cam surface 66 engages the second engaging surface 72 of the striker assembly 30. It should be appreciated that the area of contact between the second engaging surface 72 and the second cam surface 66 moves relative to the second cam surface 66 and the second engaging surface 72 as the latch mechanism 32 moves along the path 38. The second cam surface 66 of the second wedge block 48 engages the latch mechanism 32 to limit lateral movement of the latch mechanism 32 in the second direction 70 relative to the path 38.

As the latch mechanism 32 moves along the path 38 toward the striker assembly 30, the striker assembly 30 comes into abutting engagement with the first wedge block 46 and/or the second wedge block 48, such as shown in FIGS. 3 and 4. More specifically, the first engaging surface 64 of the striker assembly 30 comes into abutting engagement with the first cam surface 58 of the first wedge block 46, and/or the second engaging surface 72 of the striker assembly 30 comes into abutting engagement with the second cam surface 66 of the second wedge block 48. As the latch mechanism 32 continues along the path 38 toward the striker assembly 30, such as shown in FIGS. 3 and 4, frictional engagement between the first engaging surface 64 and the first cam surface 58 rotates the first wedge block 46. As the first wedge block 46 rotates, the continuously changing first variable distance 60 between the first cam surface 58 and the first axis 50 interacts with the first engaging surface 64 to maintain abutted engagement between the first engaging surface 64 and the first cam surface 58. Similarly, frictional engagement between the second engaging surface 72 and the second cam surface 66 rotates the second wedge block 48. As the second wedge block 48 rotates, the continuously changing second variable distance 68 between the second cam surface 66 and the second axis 54 interacts with the second engaging surface 72 to maintain abutted engagement between the second engaging surface 72 and the second cam surface 66. Accordingly, it should be appreciated that the shape and/or orientation of the first cam surface 58 determines the rate of change of the first variable distance 60 between the first cam surface 58 and the first axis 50. Similarly, the shape and/or orientation of the second cam surface 66 determines the rate of change of the second variable distance 68 between the second cam surface 66 and the second axis 54.

The striker assembly 30 may further include a first biasing device 74 and a second biasing device 76. The first biasing device 74 interconnects the first wedge block 46 and the housing 42. The first biasing device 74 biases the first wedge block 46 in a first rotational direction 78 about the first axis 50 into a receiving position. The receiving position of the first wedge block 46, which is shown in FIG. 2, is the position of the first wedge block 46 when ready to initially engage the striker assembly 30. The second biasing device 76 interconnects the second wedge block 48 and the housing 42. The second biasing device 76 biases the second wedge block 48 in a second rotational direction 80 about the second axis 54 into a receiving position. The second rotational direction 80 is opposite the first rotational direction 78. The receiving position of the second wedge block 48, which is shown in FIG. 2, is the position of the second wedge block 48 when ready to initially engage the striker assembly 30. The first biasing device 74 and the second biasing device 76 may each include any device capable of rotationally biasing the first wedge block 46 and the second wedge block 48 respectively. For example, the first biasing device 74 and the second biasing device 76 may each include but are not limited to a coil spring or other similar device.

As shown in FIGS. 2 and 3, the latch mechanism 32 is aligned along the path 38 such that a longitudinal axis 82 of the latch mechanism 32 is coaxially aligned with the path 38. However, it should be appreciated that the longitudinal axis 82 of the latch mechanism 32 may be offset from the path 38, such as shown in FIG. 4. This may be referred to as the latch mechanism 32 being misaligned from the path 38. Referring to FIG. 4, when the latch mechanism 32 is misaligned from the path 38, the first wedge block 46 and the second wedge block 48 are still capable of independently engaging the striker assembly 30, and limiting lateral movement of the latch mechanism 32 in both the first direction 62 and the second direction 70 relative to the striker assembly 30. It should be appreciated that the interaction between the first cam surface 58 and the first engaging surface 64, and the relative positions therebetween may differ from the interaction between the second cam surface 66 and the second engaging surface 72. For example, if the latch mechanism 32 is offset from the path 38 toward the first wedge block 46, then the first engaging surface 64 contacts the first cam surface 58 at a location nearer the first axis 50 than when the latch mechanism 32 is aligned along the path 38. Concurrently, the second engaging surface 72 contacts the second cam surface 66 at a location farther from the second axis 54 than when the latch mechanism 32 is aligned along the path 38. However, once contacted, the frictional engagement between the first cam surface 58 and the first engaging surface 64, and between the second cam surface 66 and the second engaging surface 72, causes both the first wedge block 46 and the second wedge block 48 to rotate and maintain the abutting engagement therebetween to limit the lateral movement of the latch mechanism 32 in both the first direction 62 and the second direction 70.

Referring to FIG. 5, an alternative embodiment of the closure assembly is generally shown at 90. The closure assembly 90 includes a striker assembly 92 and a latch mechanism 94 similar in operation to those described above in relation to FIGS. 2 through 4. Notably different, however, the striker assembly 92 includes a first plate 96 and a second plate 98 disposed on opposite sides of the path 38. The first plate 96 is disposed in the first side 52 of the path 38, and the second plate 98 is disposed on the second side 56 of the path 38. The first plate 96 and the second plate 98 extend outward from the base 34 of the striker assembly 92 to define the first engaging surface 100 and the second engaging surface 102 respectively. The first engaging surface 100 is angled relative to the path 38 of the latch mechanism 94 to define a first acute angle 104 therebetween. Similarly, the second engaging surface 102 is angled relative to the path 38 of the latch mechanism 94 to define a second acute angle 106 therebetween.

The latch mechanism 94 includes a first wedge block 108 defining a first cam surface 110, and a second wedge block 112 defining a second cam surface 114, similar to those described above in relation to FIGS. 2 through 4. The first wedge block 108 and the second wedge block 112 are at least partially disposed and rotatably supported by a housing 116 of the latch mechanism 94. The first cam surface 110 and the second cam surface 114 engage the first engaging surface 100 and the second engaging surface 102 of the striker assembly 92 to restrict lateral movement of the latch mechanism 94 relative to the striker assembly 92 in both the first direction 62 and the second direction 70.

As the latch mechanism 94 moves along the path 38 toward the striker assembly 92, the striker assembly 92 comes into abutting engagement with the first wedge block 108 and/or the second wedge block 112. More specifically, the first engaging surface 100 of the first plate 96 on the striker assembly 92 comes into abutting engagement with the first cam surface 110 of the first wedge block 108, and/or the second engaging surface 102 of the second plate 98 on the striker assembly 92 comes into abutting engagement with the second cam surface 114 of the second wedge block 112. As the latch mechanism 94 continues along the path 38 toward the striker assembly 92, frictional engagement between the first engaging surface 100 and the first cam surface 110 rotates the first wedge block 108 about a first axis 118. As the first wedge block 108 rotates, the continuously changing first variable distance 60 between the first cam surface 110 and the first axis 118 interacts with the first engaging surface 100 to maintain abutted engagement between the first engaging surface 100 and the first cam surface 110. Similarly, frictional engagement between the second engaging surface 102 and the second cam surface 114 rotates the second wedge block 112 about a second axis 120. As the second wedge block 112 rotates, the continuously changing second variable distance 68 between the second cam surface 114 and the second axis 120 interacts with the second engaging surface 102 to maintain abutted engagement between the second engaging surface 102 and the second cam surface 114.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A closure assembly for securing a moveable panel relative to a body of a vehicle, the closure assembly comprising:
a striker assembly having a base and a wire striker fixedly attached to the base; and
a latch mechanism moveable along a path relative to the striker assembly and including a housing supporting a lock bolt moveable between a closed position engaging the wire striker in interlocking engagement to secure the latch mechanism relative to the striker assembly, and an open position disengaged from the wire striker to allow movement of the latch mechanism along the path relative to the striker assembly;
wherein the latch mechanism includes a first wedge block supported by and rotatably attached to the housing for rotation about a first axis; and
wherein the first wedge block includes a first cam surface defining a variable distance between the first cam surface and the first axis for engaging the striker assembly as the latch mechanism moves along the path to limit lateral movement of the latch mechanism in a first direction transverse relative to the path.

2. A closure assembly as set forth in claim 1 wherein the striker assembly includes a first engaging surface for engaging the first cam surface.

3. A closure assembly as set forth in claim 2 wherein the first engaging surface is defined by the wire striker.

4. A closure assembly as set forth in claim 2 wherein the striker assembly includes a first plate extending outward from the base of the striker assembly to define the first engaging surface.

5. A closure assembly as set forth in claim 4 wherein the first engaging surface is angled relative to the path of the latch mechanism to define an acute angle therebetween.

6. A closure assembly as set forth in claim 1 wherein the latch mechanism includes a first biasing device interconnecting the first wedge block and the housing, and wherein the first biasing device biases the first wedge block in a first rotational direction about the first axis into a receiving position.

7. A closure assembly as set forth in claim 1 wherein the latch mechanism includes a second wedge block supported by and rotatably attached to the housing for rotation about a second axis, wherein the second wedge block is disposed opposite the first wedge block across the path.

8. A closure assembly as set forth in claim 7 wherein the second wedge block includes a second cam surface defining a variable distance between the second cam surface and the second axis for engaging the striker assembly as the latch mechanism moves along the path to limit lateral movement of the latch mechanism in a second direction transverse relative to the path, wherein the second direction is opposite the first direction.

9. A closure assembly as set forth in claim 7 wherein the striker assembly includes a second engaging surface for engaging the second cam surface.

10. A closure assembly as set forth in claim 9 wherein the second engaging surface is defined by the wire striker.

11. A closure assembly as set forth in claim 9 wherein the striker assembly includes a second plate extending outward from the base of the striker assembly to define the second engaging surface.

12. A closure assembly as set forth in claim 11 wherein the second engaging surface is angled relative to the path of the latch mechanism to define an acute angle therebetween.

13. A closure assembly as set forth in claim 7 wherein the latch mechanism includes a second biasing device interconnecting the second wedge block and the housing, and wherein the second biasing device biases the first wedge block in a second rotational direction about the second axis into a receiving position.

14. A closure assembly as set forth in claim 7 wherein the first wedge block is rotatable relative to the housing independently of the second wedge block.

15. A closure assembly as set forth in claim 7 wherein the housing defines an interior space, and wherein the first wedge block and the second wedge block are both at least partially disposed within the interior space of the housing.

16-20. (canceled)
